(19) United States
(12) Patent Application Publication
(10) Pub. No.: US 2014/0030504 A1
(43) Pub. Date: Jan. 30, 2014

(54) ELECTROLESS PLATED FILM INCLUDING PHOSPHORUS, BORON AND CARBON NANOTUBE

(71) Applicant: SHINKO ELECTRIC INDUSTRIES CO., LTD., Nagano (JP)

(72) Inventors: Kenji KAWAMURA, Nagano (JP); Yoriyuki Suwa, Nagano (JP); Yuji Usui, Nagano (JP); Masao Nakazawa, Nagano (JP)

(73) Assignee: SHINKO ELECTRIC INDUSTRIES CO., LTD.

(21) Appl. No.: 13/936,414

(22) Filed: Jul. 8, 2013

(30) Foreign Application Priority Data
Jul. 25, 2012 (JP) 2012-164949

(51) Int. Cl. C09D 5/26

(52) U.S. Cl. CPC C09D 5/26
USPC 428/220; 252/71; 252/75; 252/76; 252/74

(57) ABSTRACT

A nickel electroless plated film includes phosphorus, boron and carbon nanotube.

### CROSS-REFERENCE TO RELATED APPLICATION

The present application is based on and claims the benefit of priority of Japanese Priority Application No. 2012-164949 filed on Jul. 25, 2012, the entire contents of which are hereby incorporated by reference.

### BACKGROUND OF THE INVENTION

1. Field of the Invention

The present invention relates to an electroless plated film including phosphorus, boron and carbon nanotube.

2. Description of the Related Art

Along with recent demands for the miniaturization, thinning and densification of electronic devices, the trend towards tightly sealing electronic devices has become remarkable. Thus, a space has been limited for providing a radiation member such as a heat sink or a heat exhauster for discharging heat generated in the electronic device. Therefore, there exists a strong demand to develop a radiation member capable of rapidly and effectively discharging heat generated by an electronic element of an electronic device to the outside.

Techniques for effectively discharging heat by such a radiation member are known. For example, selection of a material having a good thermal conductivity such as copper, nickel or the like as a material for the radiation member (base material), design of the shape of the radiation member to have a large surface area, and the coating of a radiation member with a metal plated film having a good thermal conductivity, and the like, are known.

Patent Documents 1 and 2 disclose Ni plating solution including carbon nano material such as carbon nanotube (CNT), carbon nanofiber or the like.

However, for example, according to a technique disclosed in Patent Document 1, it is necessary to set the temperature of the plating solution to be 50° C. or less, so it is difficult to obtain the sufficient plating speed and plating thickness.

Patent Documents 3 and 4 disclose Ni plating solution including phosphorus and boron.

### PATENT DOCUMENTS

[Patent Document 1] Japanese Laid-open Patent Publication No. 2010-215977

[Patent Document 2] Japanese Laid-open Patent Publication No. 2010-222707

[Patent Document 3] Japanese Laid-open Patent Publication No. H08-158058

[Patent Document 4] Japanese Laid-open Patent Publication No. 2008-280551

### SUMMARY OF THE INVENTION

The present invention is made in light of the above problems, and provides a nickel electroless plated film comprising phosphorus, boron and carbon nanotube.

The present inventors have studied the above problem and found that a nickel electroless plated film including phosphorus, boron and carbon nanotube can be obtained by performing electroless plating using nickel electroless plating solution including phosphorus, boron and carbon nanotube.

According to an embodiment, there is provided a nickel electroless plated film including phosphorus, boron and carbon nanotube (hereinafter, referred to as “Ni—P—B—CNT film”).

According to another embodiment, there is provided a radiation member coated by a nickel electroless plated film including phosphorus, boron and carbon nanotube.

According to another embodiment, there is provided a composite electroless plating solution including nickel metallic salt, a complexing agent, at least two kinds of reducing agents, carbon nanotube and a dispersing agent.

According to another embodiment, there is provided a method of electroless plating including: immersing a radiation member (base material to be coated) in the above composite electroless plating solution at a temperature range of 50° C.-90° C. for 5-60 minutes to form a nickel electroless plated film including phosphorus, boron and carbon nanotube on the radiation member with a thickness of at least 5 μm.

Note that also arbitrary combinations of the above-described elements, and any changes of expressions in the present invention, made among methods, devices, systems and so forth, are valid as embodiments of the present invention.

### BRIEF DESCRIPTION OF THE DRAWINGS

Other objects, features and advantages of the present invention will become more apparent from the following detailed description when read in conjunction with the accompanying drawings.

FIG. 1A to FIG. 1D are views illustrating a surface of a Ni—P—B film;

FIG. 1E to FIG. 1H are views illustrating a surface of a Ni—P—B—CNT film of an embodiment;

FIG. 2A is a view illustrating an EDX spectral analysis of the Ni—P—B film;

FIG. 2B is a view illustrating an EDX spectral analysis of the Ni—P—B—CNT film of an embodiment; and

FIG. 3 is a graph illustrating radiation characteristics of the Ni—P—B—CNT film of the embodiment and a comparative Ni plated film.

### DETAILED DESCRIPTION OF THE PREFERRED EMBODIMENTS

The invention will be described herein with reference to illustrative embodiments. Those skilled in the art will recognize that many alternative embodiments can be accomplished using the teachings of the present invention and that the invention is not limited to the embodiments illustrated for explanatory purposes.

It is to be noted that, in the explanation of the drawings, the same components are given the same reference numerals, and explanations are not repeated.

(Plated Film)

The shape (the size, the thickness, the three dimensional shape or the like) of the plated film (Ni—P—B—CNT film) of the embodiment is not particularly limited and may be the same as a plated film obtained by known electroless plating. The plated film may take various shapes in accordance with a surface shape (the size, the thickness, the three dimensional shape or the like) of a base material to be coated.

When the base material to be coated is a radiation member (a heat sink or the like) for an electronic device, for example, the size of the plated film is to cover the entirety of the surface or a part of the surface of the radiation member. At this time, the thickness of the plated film may be set such that the radiation member can show the optimum heat transmission effect and radiation effect. For example, the thickness of the plated film may be at least 2 μm, more preferably at least 5 μm, and further more preferably at least 10 μm. The plated film of the embodiment can be coated on a surface of the base material to be coated with a constant thickness even when the base material has a complicated three dimensional structure.

The plated film of the embodiment includes carbon nanotube in a Ni—P—B alloy. Ni—P—B alloy means a nickel phosphorus boron alloy plated film obtained by an electroless method (electroless plating, for example). Here, carbon nanotube means a carbon material or a material including the carbon material, as will be explained later in detail. Thus, the plated film of the embodiment includes at least nickel, phosphorus, boron and carbon nanotube.

In this embodiment, “carbon nanotube” is a kind of known carbon nano material and is a fibrous carbon nano material having a diameter range of 1 nm-5 μm and a length range of 0.5 μm-1000 μm. The carbon nanotube may be single walled or multi walled. The carbon nanotube of the embodiment may be synthesized by a known method (for example, arc discharge, laser ablation, or chemical vapor deposition (CVD)). Alternatively, a commercially available product may be used. In this embodiment, the carbon nanotube may be further be processed. For example, the size of the carbon nanotube may be changed by a mechanical process or the like.

Further in this embodiment, two or more kinds of carbon nanotubes may be used. For example, two or more kinds of carbon nanotubes whose diameters or lengths are different from each other may be used together.

In the plated film of the embodiment, the carbon nanotube and the Ni—P—B alloy may be evenly dispersed or unevenly dispersed.

Preferably, the carbon nanotube and the Ni—P—B alloy may be evenly dispersed. Further, the carbon nanotube may be dispersed in the entirety of the plated film. Alternatively, the carbon nanotube may be formed at a surface portion or a middle portion of the plated film. Further alternatively, the carbon nanotube may be locally formed at an arbitrary part of the plated film. At any case, the carbon nanotube may be evenly dispersed. Further, the carbon nanotube may be locally formed at the surface portion of the plated film. For example, Ni—P—B alloy may be deposited on the carbon nanotube included in the Ni—P—B alloy.

The contents of nickel, phosphorus, boron and carbon nanotube included in the plated film of the embodiment may not be particularly limited. The contents may be appropriately determined based on the character of the plated film, the combination with the base material to be coated or the like.

For example, the plated film of the embodiment may include 80-98 weight % of Ni, 0.5-12 weight % of phosphorus, 0.05-2 weight % of boron and 0.05-10 weight % of carbon nanotube, with respect to the total amount, respectively. In particular, when the base material to be coated is the radiation member, the plated film of the embodiment may include 96.5-98% of Ni, 2-5% of phosphorus, 0.5-1% of boron and 1-2% of carbon nanotube, with respect to the total amount, respectively.

The shape of the plated film of the embodiment (the size, the thickness, the three dimensional shape or the like) may be obtained by measuring the plated film or the surface of the base material coated by the plated film using various known surface analyzing methods. The size, the thickness and the uniformity of the plated film surface are observed and measured by viewing, an optical microscope, an electron microscope or the like. Similarly, the carbon nanotube included in the plated film is observed and measured by an electron microscope, for example. Specifically, the carbon nanotube is observed or measured by observing the surface of the plated film by a scanning electron microscope, or by cutting the plated film and observing the cut surface by a scanning electron microscope.

Each of the components included in the plated film may be quantitatively analyzed using known various analyzing methods, if necessary. The analyzing methods include a so-called wet analysis or dry analysis. For the wet analysis, for example, components in solution obtained by dissolving the plated film in appropriate acid (hydrochloric acid, nitric acid, sulfuric acid or the like, for example) may be analyzed using an appropriate analyzing method for each of the components. Specifically, Ni, phosphorus and boron may be analyzed by ICP or atomic absorption spectrometry. The carbon nanotube precipitates without being dissolved in such acid. Thus, the precipitated component (carbon nanotube) may be measured by gravimetric analysis, or the shape of the precipitated component (carbon nanotube) may be measured by an electron microscope.

For the dry analysis, a surface analysis such as energy-dispersive X-ray diffraction (EDX) or the like may be used. In this case, components that are included near the surface of the plated film may be locally analyzed and quantitatively analyzed, if necessary.

(Radiation Member)

The radiation member as the base material (which will be referred to as “base radiation member”) of the embodiment is coated by the above described plated film of the embodiment. The material, the size and the shape of the base radiation member is not particularly limited. Various base radiation members that have been generally plated by nickel plating may be used for the base material.

According to the plating of the embodiment, even when the surface of the base radiation member has a complicated concavo-convex shape (a so-called macro-scale or micro-scale), the plated film with a constant thickness can be formed along the shape of the base radiation member.

The material of the base radiation member may be, specifically, metal, metal alloy, resin, composite resin of resin and another composite object or the like. The method of plating of the embodiment is adaptable for metal and metal alloy such as for the base radiation member. The size of the base radiation member is not particularly limited and the plating conditions, which will be explained in the following, may be arbitrarily selected in accordance with the size of the base material to be coated such as the base radiation member.

The base radiation member may have a complicated combination of a curved or bent surface, a folded portion, concavo-convex or the like, not only a flat surface, as the entirety of the base radiation member (macro-scale or micro-scale). Concavo-convex means to have a height difference (between a concave portion and a convex portion) of a few μm to a few mm. Concavo-convex aspect ratio means a ratio of the depth with respect to the width of the concave portion. Specifically, the base radiation member may be a radiation plate (including a heat sink, a heat spreader or the like) of an electronic device or an electronic element provided with a concavo-convex shape such as a groove shape, a lattice shape or the like at its surface in order to increase the surface area.

According to the plating of the embodiment, Ni—P—B—CNT film with a constant thickness can be coated on a surface of the base material to be coated along the shape of the base material even when the base material has a complicated shape. With this, the radiation member of the embodiment can show extremely good radiation characteristics.

### (Composite Electroless Plating Solution)

The composite electroless plating solution of the embodiment is capable of forming the above described Ni—P—B—CNT film by electroless plating. The composite electroless plating solution of the embodiment includes nickel metallic salt, a complexing agent, at least two kinds of reducing agents, carbon nanotube and a dispersing agent.

The nickel metallic salt of the embodiment may not be particularly limited and nickel metallic salt that is used in general nickel electroless plating solution may be used. For example, nickel sulfate, nickel bromide, nickel chloride, nickel sulfamate or the like may be used.

The content of the nickel metallic salt is not particularly limited. The content of the nickel metallic salt may be similar to that used in general electroless nickel plating solution, and may be, for example, within a range of 10-400 g/L, specifically within a range of 10-200 g/L, and more preferably within a range of 10-100 g/L.

The complexing agent of the embodiment may not be particularly limited and a complexing agent used in general nickel electroless plating solution may be used. One of the functions of the complexing agent is to form complex with nickel ion to stabilize the nickel ion in the plating solution. The complexing agent may be, although not limited, amino compound such as ethylenediamine or the like, monocarboxylic acid such as glycolic acid, lactic acid, gluconic acid, propionic acid or the like, dicarboxylic acid such as tartaric acid, malic acid, succinic acid, malonic acid or the like, tricarboxylic acid such as citric acid or the like, and salt, for example, sodium salt, potassium salt, ammonium salt or the like, of these.

The content of the complexing agent is not particularly limited. The content of the complexing agent may be similar to that used in general electroless nickel plating solution, and may be, for example, within a range of 10-100 g/L.

According to the embodiment, the composite electroless plating solution includes at least two kinds of reducing agents, each having a function to reduce nickel ion to deposit nickel metal. The reducing agent used for general nickel electroless plating solution includes a reducing agent based on a phosphorus compound, a reducing agent based on a boron compound, a reducing agent based on a hydrazine compound or the like. In this embodiment, among these, at least the reducing agent based on the phosphorus compound and the reducing agent based on the boron compound are used.

The phosphorus compound may be, although not limited, hypophosphite, hypophosphitesodium, hypophosphitepotassium, hypophosphitenickel, hypophosphitecalcium or the like. In this embodiment, one or more of these phosphorus compounds may be used.

The boron compound may be, although not limited, dimethylaminoboron, diethylaminoboron, sodium borohydride or the like. In this embodiment, one or more of these boron compounds may be used.

The total content of these two kinds of reducing agents (phosphorus compound and boron compound) included in the plating solution is not particularly limited, but may be within a range of 10-50 g/L, and the content of the boron compound is within a range of 1-10 g/L.

The carbon nanotube of the embodiment is not particularly limited, and the carbon nanotube having a known size, shape and characteristics may be used. In this embodiment, the shape of the carbon nanotube may be, a diameter of within a range of 1 nm-5 μm, more preferably within a range of 10 nm-500 nm and a length of within a range of 0.5-1000 μm, and more preferably within a range of 1-100 μm. The carbon nanotube may be single walled or multi walled. When used for the above described base radiation member, the aspect ratio (length/diameter) of the carbon nanotube may be within a range of 100-1000.

The content of the carbon nanotube is not particularly limited, however, for example, the content of the carbon nanotube may be within a range of 0.05-5 g/L.

One of the functions of the dispersing agent of the embodiment is to disperse the carbon nanotube in the plating solution in a stabilized manner. In this embodiment, the kind of dispersing agent is not particularly limited and a dispersing agent known for a general nano-carbon material may be used. For example, anionic surface active agent, cationic surface active agent, nonionic surface-active agent, nonionic water-soluble organic high polymer, ampholytic surface active agent, amphoteric water-soluble organic high polymer, a water-soluble organic high polymer dispersing agent, organic high polymer cation, cyclodextrin or the like may be used. In particular, the water-soluble organic high polymer dispersing agent may be used. Specifically, polyacrylic acid, styrene-methacrylic acid copolymer, acrylic acid alkyl ester-acrylic acid copolymer, styrene-methacrylic acid phenyl ester-methacrylic acid copolymer, alginic acid, hyaluronic acid or the like may be used. Among these, polyacrylic acid may be used. The cationic surface active agent may be used as the dispersing agent and in particular, trimethyl-cetyl ammonium salt may be used.

Further, the composite electroless plating solution of the embodiment may further include various addition agents in accordance with necessity. For example, the composite electroless plating solution of the embodiment may include pH regulator such as nickel carbonate or the like for regulating pH, a surface-active agent for preventing pit, or a brightening agent such as saccharin sodium or the like.

The method of manufacturing or preparing the composite electroless plating solution of the embodiment may not be particularly limited. The composite electroless plating solution may be obtained by mixing the above explained components at desired contents and dispersing the carbon nanotube using a stirring device or a supersonic device, if necessary. The composite electroless plating solution may be previously prepared and stored. Alternatively, the composite electroless plating solution may be prepared when the solution is used. When the composite electroless plating solution is previously prepared and stored, if necessary, the plating solution may be stirred before it is used for the plating by an appropriate method so that the carbon nanotube can be finely dispersed.

The components and the contents of the composite electroless plating solution may be analyzed using a general analyzing method. For example, for analyzing nickel ion, a general qualitative/quantitative analyzing method for water-soluble nickel ion may be used. Specifically, general nickel ion qualitative analyzing method or quantitative analyzing method such as ion chromatograph, atomic absorption analysis or the like may be used. The content of the carbon nanotube may be measured by precipitating the carbon nanotube from the plating solution and measuring the amount. The shape of the carbon nanotube may be measured by observing the precipitated carbon nanotube using an electron microscope.

The dispersing agent (for example, polyacrylic acid) may be analyzed by separating the dispersing agent using column chromatography with fillers of general adsorption, ion-exchange or the like, and quantitatively and qualitatively analyzing the separated substance by various instrumental analyses (NMR, IR, UV-VIS or the like).

### (Plating)

The plating of the embodiment is to form the Ni—P—B—CNT film using the composite electroless plating solution of the embodiment. The base material to be plated by the plating of the embodiment is not particularly limited. Any base materials usually capable of being plated by a general electroless nickel plating solution may be used so that the electroless Ni—P—B—CNT film is formed at a surface of the base material. Specifically, the base material may be a base radiation member such as a heat sink for an electronic device.

The condition for the plating of the embodiment is not particularly limited and a general condition and apparatus for nickel electroless plating may be used. For example, the plating may be performed by immersing the base material, which is an object to be plated, such as a base radiation member into a plating bath including the composite electroless plating solution at a predetermined temperature for a predetermined period. The temperature is a range within which the plating solution can be sufficiently stable during the plating, and may be for example, within a range of 50° C.-90° C. The immersing period may be selected based on the desired thickness of the plated film and the temperature of the plating of the embodiment solution. For example, a plated film having a thickness of 10 μm may be obtained by immersing the object to be plated at 60° C. for 60 minutes.

The plating solution may be stirred while plating. The plating of the embodiment is not limited to batch type by which the plating solution in the plating bath is exchanged every time the plating is performed. Alternatively, a continuous type by which some of the components are added at an appropriate timing or added successively so that the plating is successively performed, as the components in the plating solution change in accordance with the progression of the plating.

The following example does not limit the scope of the invention.

### EXAMPLE

(Preparation of Composite Electroless Plating Solution)

1 g of carbon nanotube (manufactured by Showa Denko K. K., the diameter of which is 150 nm, the length of which is 15 μm) and 0.3 g of trimethyl-cetyl ammonium chloride (manufactured by Tokyo Chemical Industry co., ltd.) as the dispersing agent were added to 500 ml of commercially available Ni—P—B plating solution (KANIBORON (registered trademark) SKB230 manufactured by Japan Kanigen co., ltd.). Then, the composite electroless plating solution was prepared by stirring the mixture by a magnetic stirrer at a slow speed to dissolve and disperse. (Ni—P—B plating solution for comparison)

For comparison, KANIBORON (registered trademark) SKB230 (manufactured by Japan Kanigen co., ltd.) was used as Ni—P—B plating solution without the carbon nanotube and the dispersing agent.

(Object to be Plated (Anode))

A pure copper plate having a size of 30 mm×30 mm×1 mm was used for an object to be plated as a sample for measuring the thickness of the plated film. After immersing the object to be plated at a predetermined temperature for a predetermined period, the sample was obtained. The thickness was measured by X-ray fluorescence. Ni, P and B included in the plated film were measured by EDX (INCA-ENERGY 250, manufactured by OXFORD).

A pure copper plate having a size of 30 mm×30 mm×1 mm was used for an object to be plated as a sample for measuring the radiation characteristics. A plated film having a thickness of 10 μm was formed.

(Electroless Plating)

The object to be plated was immersed in the composite electroless plating solution and the Ni—P—B plating solution for comparison set at 45° C., 60° C. or 90° C., respectively, while stirring by the magnetic stirrer at a slow speed. The plating periods were 30, 60, 90, 120 or 150 minute. The object to be plated was taken out from the plating solution for every 30 minutes to view the plated film, measure the thickness and analyze the components. The obtained results are summarized below.

(Evaluation of Radiation Characteristics)

Evaluation of radiation characteristics was performed as follows. A ceramic heater was attached to a predetermined copper block, and the pure copper plate plated by the composite electroless plating solution or the Ni—P—B plating solution was placed on and fixed to the copper block by an adhesive agent. A temperature gage was inserted into a hole provided in the copper block. Then, a constant voltage is applied to the heater for 60 minutes and the temperature was measured by a temperature gage. Voltage, current, electric power (W) were 25.0000 V, 0.17534 A and 3825 W, respectively.

### (Result)

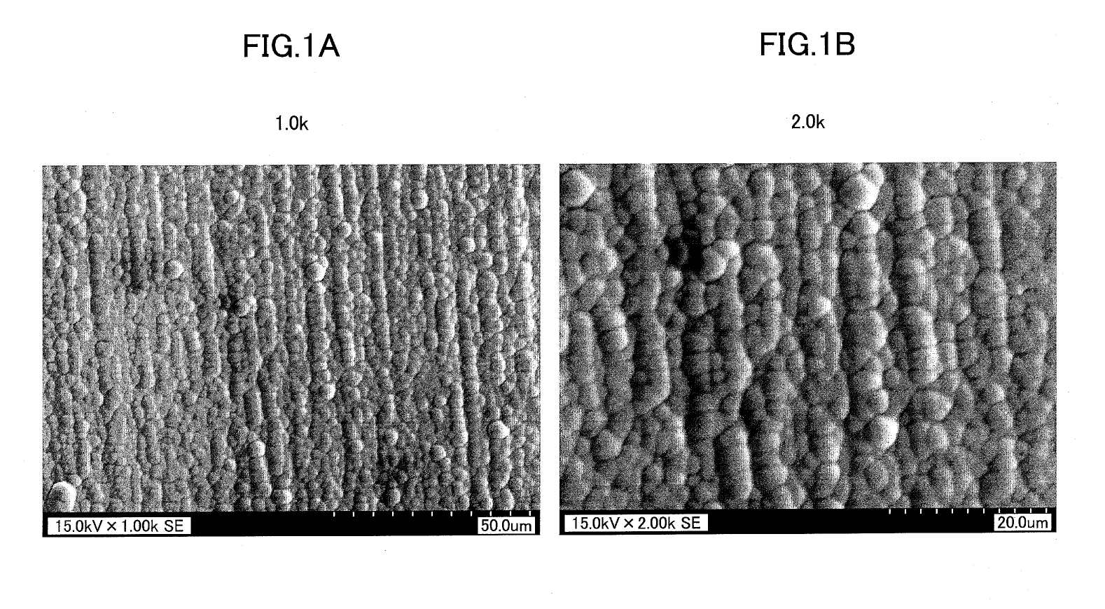

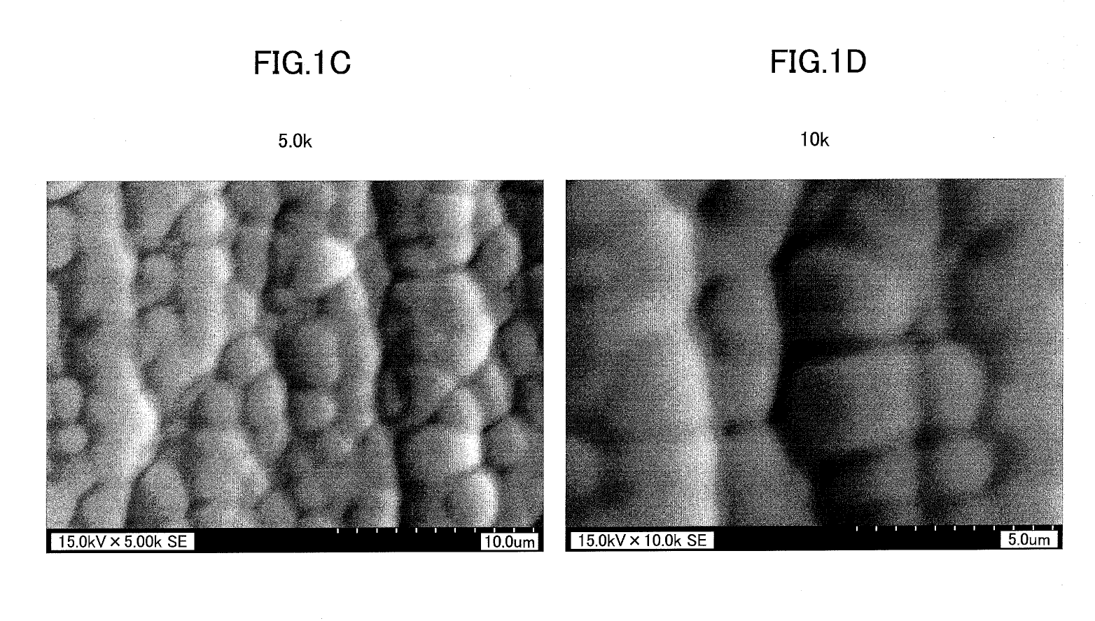

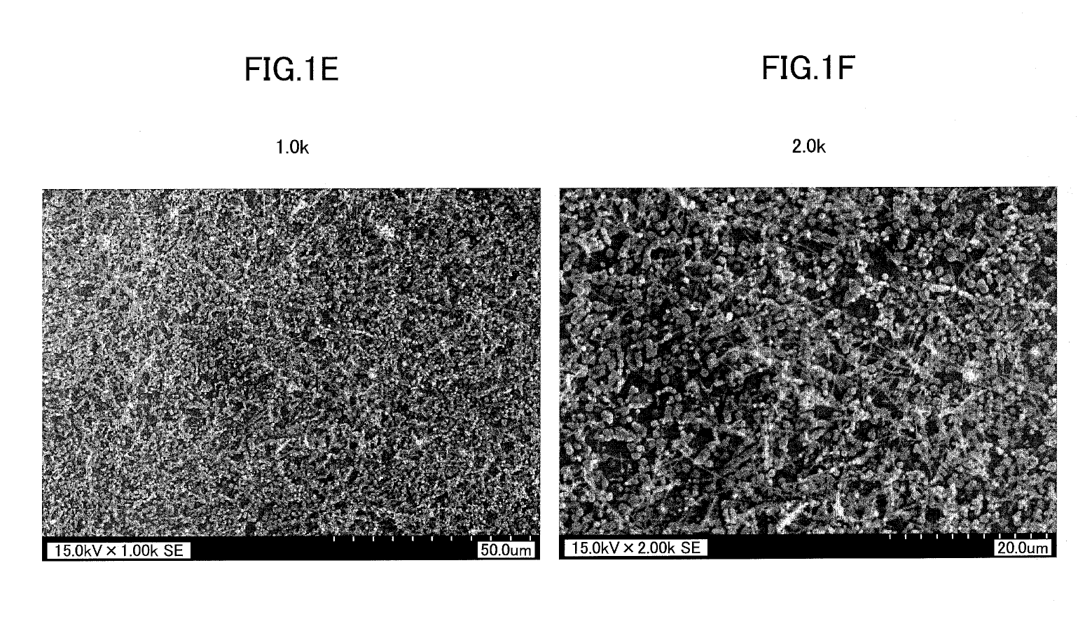

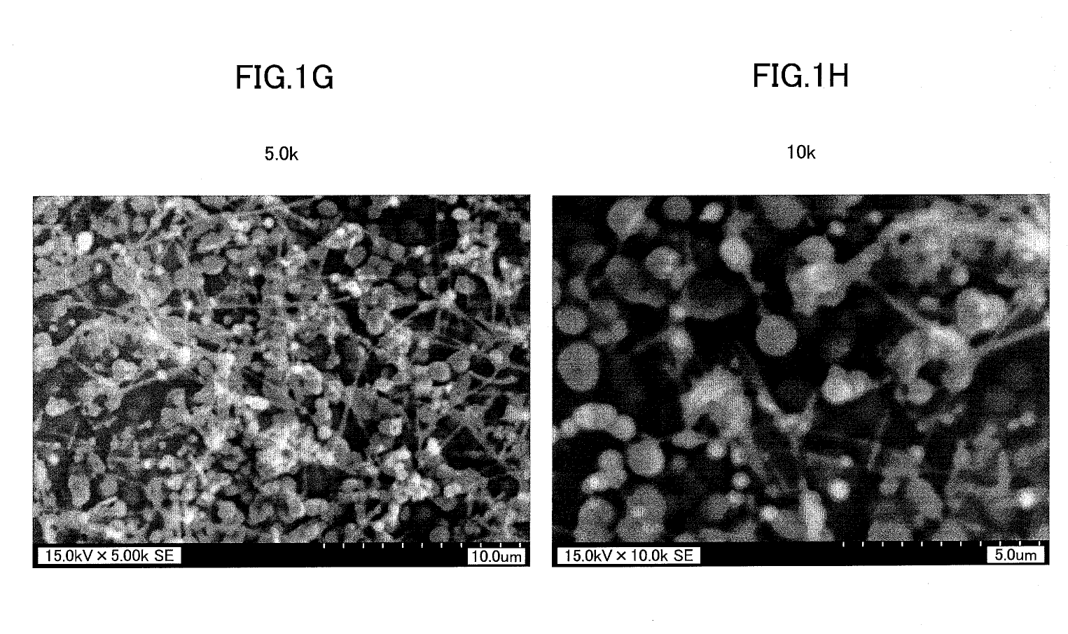

(1) The surfaces of the plated film obtained by using the composite electroless plating solution (Ni—P—B—CNT film) and the plated film obtained by using the comparative Ni—P—B plating solution (Ni—P—B film, comparative) were observed by an electron microscope, respectively. FIG. 1A to FIG. 1D are views illustrating the surface of the Ni—P—B film. FIG. 1E to FIG. 1H are views illustrating the surface of the Ni—P—B—CNT film. FIG. 1A to FIG. 1D show the views of 1000 times, 2000 times, 5000 times and 10000 times, respectively. Similarly, FIG. 1E to FIG. 1H show the views of 1000 times, 2000 times, 5000 times and 10000 times, respectively.

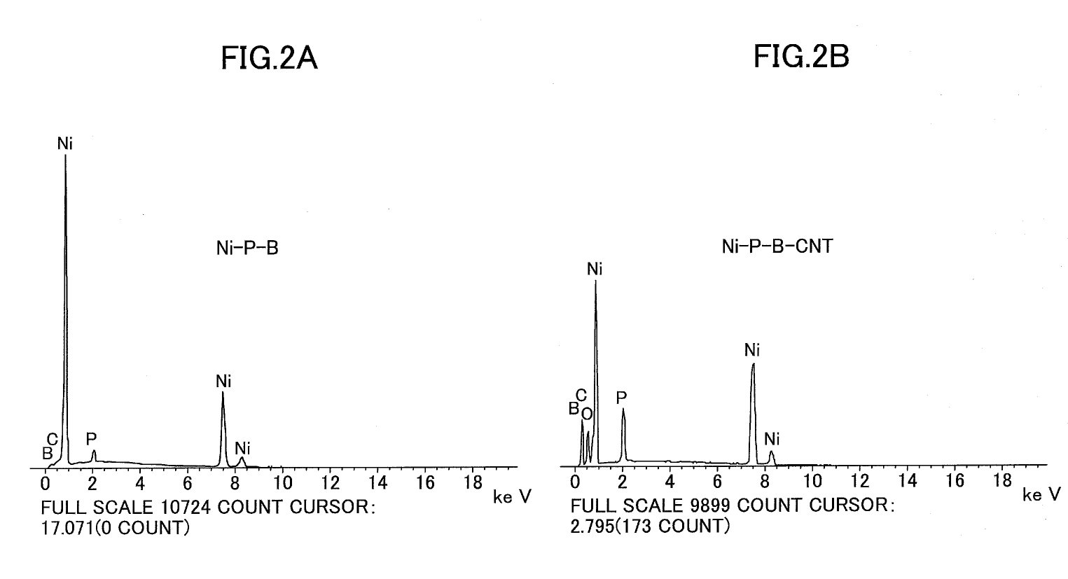

Compared with the surface of the comparative Ni—P—B film, it can be understood that (i) there are a lot of carbon nanotube in a fiber form at the surface of the Ni—P—B—CNT film, (ii) a part of the carbon nanotube protrudes from the surface and Ni—P—B is further partially deposited on the carbon nanotube, and (iii) the size of the crystal grain of the Ni—P—B alloy is very small for the Ni—P—B—CNT film. These results show that when the Ni—P—B—CNT film is coated on a surface of the base radiation member, for example, the radiation characteristics and the mechanical characteristics can be more improved compared with the Ni—P—B film.
(2) The Ni—P—B—CNT film and the comparative Ni—P—B film were examined by EDX spectrum, respectively. FIG. 2A is a view illustrating an EDX spectral analysis of the Ni—P—B film. FIG. 2B is a view illustrating an EDX spectral analysis of the Ni—P—B—CNT film of an embodiment. For the Ni—P—B film shown in FIG. 2A, peaks of Ni, P and B exist. For the Ni—P—B—CNT film shown in FIG. 2B, a peak of C also exists in addition to peaks of Ni, P and B. The peaks and the intensity obtained from the spectrums are also illustrated in Table 1.

TABLE 1

| SPECTRUM | B | C | O | Na | P | Ni | TOTAL |
|---|---|---|---|---|---|---|---|
| Ni—P—B | 4.42 | 2.65 | 0.15 | 0.07 | 1.99 | 90.72 | 100 |
| Ni—P—B-CNT | 13.48 | 28.33 | 7.38 | 0.15 | 5.55 | 45.11 | 100 |

This result illustrates, with the above result by the electron microscope, that the Ni—P—B—CNT film of the embodiment is a Ni—P—B alloy including the carbon nanotube.
(3) The plating was performed using the composite electroless plating solution of the embodiment at 60° C. The relationship between the plating period (minutes) and the obtained thickness (μm) of the Ni—P—B—CNT was 30 minute: 2.5 μm, 60 minutes: 5 μm, 90 minutes: 7.5 μm, 120 minutes: 10 μm, 150 minutes: 11.5 μm.

The plating was also performed at 45° C. and the thickness was not increased even after the plating period of 30 minutes.

As a result, according to the composite electroless plating solution of the embodiment, the following results can be obtained.

(i) The composite electroless plating solution can be stably used even near 60° C.

(ii) The plating speed is stably constant (about 5 μm/60 minutes) more than or equal to two hours even at 60° C. so that the thickness of the film can be accurately controlled.

(iii) The plated film having a thickness more than or equal to 5 μm (or more than or equal to 10 μm), which is necessary for a radiation member, can be formed within a short period.

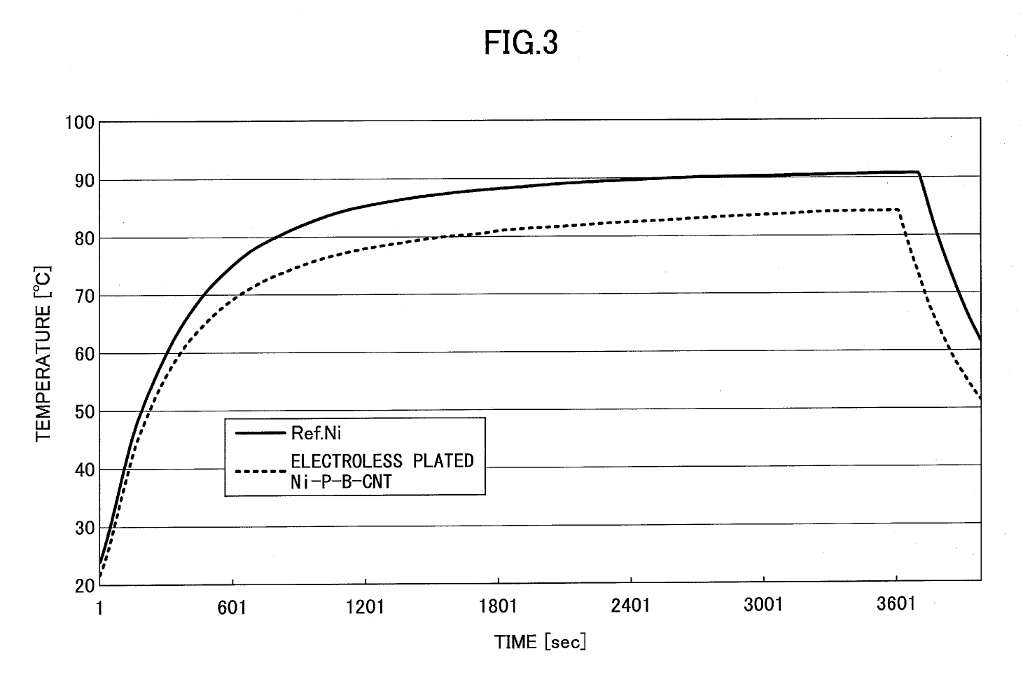

Similarly, as a result of performing plating at 75° C. and 90° C., respectively, the composite electroless plating solution of the embodiment was sufficiently stable at 75° C. and actualized a preferable plating speed. With this result, it can be understood that the plating solution of the embodiment can be used within a wide temperature range about 50° C. to 75° C.
(4) For comparison, electroless Ni—P plating solution including carbon nanotube but not including boron (similar to Patent Document 1) was prepared. The plating was performed at 45° C., 60° C. or 90° C. Pb (lead) or lead salt was used as the stabilizing agent.
45° C. (without stabilizing agent): the thickness was constantly increased until 150 minutes, however, the thickness was still about 6 μm after 150 minutes.
60° C. (with stabilizing agent): the thickness became 5 μm at 30 minutes, however, the plating solution was autolyzed within 60 minutes. 90° C. (with stabilizing agent): the plating solution was autolyzed within 30 minutes.
(5) Evaluation of radiation characteristics of the Ni—P—B—CNT film of the embodiment was performed. For comparison, the Ni plated film was also examined. FIG. 3 illustrates a measuring result within 60 minutes (3600 seconds). The temperature was lowered about 10° C. for the Ni—P—B—CNT film compared with the Ni plated film. With this result, it can be understood that the radiation characteristics can be largely improved by including carbon nanotube.

Various aspects of the subject-matter described herein are set out non-exhaustively in the following numbered cluses:

1. A method of electroless plating comprising:
immersing a radiation member in composite electroless plating solution at a temperature range of 50° C.-90° C. for 5-60 minutes to form a nickel electroless plated film including phosphorus, boron and carbon nanotube on the radiation member with a thickness of at least 5 μm,
the composite electroless plating solution including nickel metallic salt, a complexing agent, at least two kinds of reducing agents, carbon nanotube and a dispersing agent.

Although a preferred embodiment of the nickel electroless plated film, the radiation member, the composite electroless plating solution and the method of electroless plating has been specifically illustrated and described, it is to be understood that minor modifications may be made therein without departing from the spirit and scope of the invention as defined by the claims.

The present invention is not limited to the specifically disclosed embodiments, and numerous variations and modifications and modifications may be made without departing from the spirit and scope of the present invention.

What is claimed is:

1. A nickel electroless plated film comprising phosphorus, boron and carbon nanotube.

2. The nickel electroless plated film according to claim 1, wherein the content of phosphorus is 0.5-12.0 weight %, the content of boron is 0.05-2.0 weight % and the content of carbon nanotube is 0.05-10 weight %.

3. The nickel electroless plated film according to claim 1, wherein the thickness of the nickel electroless plated film is more than or equal to 5 μm.

4. A radiation member coated by the nickel electroless plated film according to claim 1.

5. The radiation member according to claim 4, wherein the content of phosphorus is 0.5-3.0 weight %, the content of boron is 0.05-2.0 weight % and the content of carbon nanotube is 0.1-10 weight % in the nickel electroless plated film.

6. The radiation member according to claim 4, wherein the thickness of the nickel electroless plated film is more than or equal to 5 μm.

7. The radiation member according to claim 4, wherein the radiation member is a heat sink for an electronic device.

8. A composite electroless plating solution comprising nickel metallic salt, a complexing agent, at least two kinds of reducing agents, carbon nanotube and a dispersing agent.

9. The composite electroless plating solution according to claim 8, wherein the at least two reducing agents are a phosphorus compound and a boron compound, respectively.

10. The composite electroless plating solution according to claim 9,
wherein the phosphorus compound is at least one selected from a group including hypophosphite, hypophosphitesodium, hypophosphitepotassium, hypophosphitenickel and hypophosphitecalcium, and
wherein the boron compound is at least one selected from dimethylaminoboron, diethylamino boron and sodium borohydride. 20

11. The composite electroless plating solution according to claim 8, wherein the dispersing agent is at least one selected from a group including polyacrylic acid, styrene-methacrylic acid copolymer, acrylic acid alkyl ester-acrylic acid copolymer, styrene-methacrylic acid phenyl ester-methacrylic acid copolymer, alginic acid and hyaluronic acid.

12. The composite electroless plating solution according to claim 8, wherein the complexing agent is at least one selected from an amino compound including ethylenediamine, monocarboxylic acid including glycolic acid, lactic acid, gluconic acid and propionic acid, dicarboxylic acid including tartaric acid, malic acid, succinic acid and malonic acid, tricarboxylic acid including citric acid, and sodium salt, potassium salt, ammonium salt of these.
